(19) United States
(12) Patent Application Publication
(10) Pub. No.: US 2014/0179521 A1
(43) Pub. Date: Jun. 26, 2014

(54) COMPOSITIONS INCORPORATING HYTd

(71) Applicant: Agrinos AS, Lysaker (NO)

(72) Inventor: Neil Douglas Fuller, Lincoln (GB)

(73) Assignee: Agrinos AS, Lysaker (NO)

(21) Appl. No.: 14/136,937

(22) Filed: Dec. 20, 2013

Related U.S. Application Data
(60) Provisional application No. 61/745,012, filed on Dec. 21, 2012.
(60) Provisional application No. 61/745,959, filed on Dec. 26, 2012.

(51) Int. Cl. C05G 3/02; A01N 43/54; A01N 59/26; A01N 63/00

(52) U.S. Cl. CPC C05G 3/02; A01N 63/00; A01N 43/54; A01N 59/26
USPC 504/101

(57) ABSTRACT

Disclosed are compositions comprising a first component comprising chitosan, glucosamine and amino acids and a second component selected from the group consisting of (i) one or more pesticides, (ii) one or more non-pesticide organic molecules, (iii) one or more plant nutritional molecules and (iv) non-pesticidal living systems. The composition can also include trace elements, protein and other polysaccharides. The composition is generally a liquid but may be a solid. In most embodiments, the solid can be reconstituted with water prior to use. In the disclosed processes soil, seed, seedling or plant foliage is contacted with the disclosed compositions to produce beneficial results.

### TECHNICAL FIELD

Agricultural processes and compositions used in such processes comprising HYTd and additional components enhance crop quality and quantity and plant defensive processes, decrease the level of plant pathogens, and reduce the amount of fertilizer and pesticide required.

### BACKGROUND OF THE INVENTION

Microbes have previously been used in agriculture. Examples include those disclosed in U.S. Pat. Nos. 4,952,229; 6,232,270 and 5,266,096.

Chitin has also been used in agriculture either as a protein complex (U.S. Pat. No. 4,536,207) or in combination with various microbes (U.S. Pat. Nos. 6,524,998 and 6,060,429).

Chitosan in combination with other components has been used in agricultural applications. See e.g. U.S. Pat. Nos. 6,649,566; 4,812,159; 6,407,040; 5,374,627 and 5,733,851. It has also been used to treat cereal crop seeds. See U.S. Pat. No. 4,978,381. U.S. Pat. No. 6,524,998 also discloses that chitosan can be used in combination with specific microbes for agricultural use.

HYTb containing chitosan, glucosamine and amino acids alone or in combination with (1) HYTc containing chitin and (2) the microbial composition HYTa are useful in the treatment of soil, seed, seedlings and foliage as disclosed in U.S. Patent Application Ser. No. 61/355,447 filed Jun. 16, 2010 entitled Microbial Process and Composition for Agricultural Use and U.S. patent application Ser. No. 13/160,333 filed Jun. 14, 2011 entitled Microbial Process and Composition, published Apr. 5, 2012, as US Patent Publication US 2012/0084886 each of which are incorporated herein by reference in their entirety.

Notwithstanding the foregoing, there is a need to provide improved compositions and processes that boost crop yield and reduce the amount of conventional fungicides and insecticides used in agricultural and horticultural applications.

### SUMMARY OF THE INVENTION

In one embodiment, the composition comprises at least two components. The first component comprises a mixture which includes chitosan, glucosamine and amino acids. In a preferred embodiment, the concentration of chitosan is greater than 1.5 wt % and the concentration of glucosamine is greater than 1.5 wt %. In yet another embodiment, the concentration of chitosan is from 2 to 2.5 wt % and glucosamine is from 2 to 6 wt %. In a preferred embodiment, the first component comprises HYTd which is the liquid phase obtained from the digestion of chitin by ATCC deposit PTA-10861 (HQE) in the presence of HYTb, where HYTb is the liquid phase from the digestion of chitin containing organisms with ATCC deposit PTA-10861 (HQE).

The second component comprises a biological control agent. A biological control agent can, for example, protect a plant from pathogens or promote plant growth. The biological control agent can be selected from the group consisting of (i) one or more pesticides, (ii) one or more non-pesticide organic molecules, (iii) one or more plant nutritional molecules and (iv) one or more non-pesticidal living systems. When there is no more than one second component in the composition, the second component does not include the microorganisms in the consortium designated ATCC deposit PTA-10973 (HYTa) and the consortium designated ATCC deposit PTA-10861 (HQE). These consortiums are also disclosed in the aforementioned US Patent Applications. Stated another way, the composition does not consist of the first component and HYTa or HQE.

The pesticide is generally chosen for its effectiveness against the pest(s) associated with a particular agricultural situation but broad-acting pesticides can also be used. In a preferred embodiment, the pesticide is an agricultural pesticide. As used herein, an agricultural pesticide is a compound or composition selected from the group consisting of fungicides, insecticides, herbicides, molluscicides, mitocide and nematicides. Agricultural pesticides may also include virucides and rodenticides. A preferred group of agricultural pesticides is selected from fungicides, insecticides and herbicides.

The pesticide can be inorganic, organic or a biological pesticide selected from of pesticidal microorganisms, including bacteria, fungi and viruses, and pesticides derived from a biological source either natural or recombinant.

The non-pesticide organic molecule can be selected from the group consisting of plant hormones, plant elicitors, microbial metabolites, plant signaling molecules, plant extracts, fatty acids and essential oils.

The plant nutritional molecules are selected from the group consisting of micro-nutrients, major nutrients and fertilizer.

The non-pesticidal living systems include bacteria, fungi and viruses.

The composition can further comprise at least one of HYTa, HYTb and HYTc, wherein HYTa comprises ATCC deposit designated PTA-10973, and HYTb and HYTc comprise respectively the liquid and solid phases obtained from the fermentation of chitin containing organisms with a microbial composition comprising ATCC deposit PTA-10861.

The process comprises contacting soil, seed, seedlings or plant foliage with the components of any of the disclosed compositions. The contacting can comprise the separate application of the first and second components, the simultaneous application of the first and second components or the application of a composition comprising the first and said second components.

The process can further comprise contacting soil, seed, seedling or plant foliage with the first and second components and additionally at least one of HYTa, HYTb and HYTc.

In another embodiment, (1) the first component or (2) the first and second component can be used to treat soil, seed, seedling or foliage which is either present in a field or transferred to a field or present in non-field situations, such as protected cropping, glass house crop production and hydroponic systems. The field or non-field production site is treated with an insect predator before, during or after the treatment with the other components.

Compositions are also disclosed comprising soil treated with or in combination with any of the disclosed compositions.

Compositions are also disclosed comprising a plant treated with or in combination with any of the disclosed compositions.

Compositions are also disclosed comprising seed or seedling treated with or in combination with any of the disclosed compositions.

### BRIEF DESCRIPTION OF THE DRAWINGS

FIG. 1 is a flow diagram showing the digestion of chitin containing crustacean to form HYTb and HYTc. The HYTc and HYTb are subsequently processed with HQE to form HYTd, a solution with relatively high amounts of chitosan and glucosamine as compared to HYTb.

FIG. 2 is a flow diagram showing the digestion of chitin containing fungi, including filamentous fungi, yeast and/or insects to form HYTb and HYTc. The HYTc and HYTb are optionally processed further with HQE to form HYTd, a solution with relatively high amounts of chitosan and glucosamine as compared to HYTb.

FIG. 3 depicts the percentage of strawberry leaf area infestation by powdery mildew for various treatments including the effect of HYTd used in combination with a second component as described in Example 3.

FIG. 4 depicts the average number of strawberry fruits and runners for various treatments including the effect of HYTd used in combination with a second component as described in Example 3.

FIG. 5 depicts the average strawberry fruit weight for various treatments including the effect of HYTd used in combination with a second component as described in Example 3.

FIG. 6 demonstrates the effect of HYTd used in combination with a second components on potato blight as disclosed in Example 4.

### DETAILED DESCRIPTION

Compositions are disclosed comprising first and second components. The compositions are useful to treat soil, seed, seedling and foliage.

The first component comprises a mixture or solution of chitosan, glucosamine and amino acids. The second component comprises a biological control agent. In some embodiments, the second component is selected from the group consisting of one or more pesticides, one or more non-pesticide organic molecules, one or more nutritional molecules and non-pesticidal living systems.

Processes are also disclosed comprising contacting soil, foliage, seed or seedling with the above first and second components. The first and second components can be applied sequentially, simultaneously or as a mixture.

First Component

The first component preferably comprises chitosan, glucosamine and amino acids. In the first component, the concentration of chitosan is preferably greater than 1.5 wt % and the glucosamine is preferably greater than 1.5 wt %. In other embodiments, the concentration of chitosan is from 2 to 2.5 wt % and glucosamine is 2 to 6 wt %.

The first components may also contain amino acids (about 5 to 12 wt %) and trace elements (about 6 wt %) including calcium, magnesium, zinc, copper, iron and manganese. It also can contain enzymes such as lactic enzymes, proteases, lipases, chitinases among others, lactic acid, polypeptides and other carbohydrates

The first component can also include solid chitin, but generally no more than about 2 wt %. The first component can also include trace elements, protein and other polysaccharides.

The first component is generally a liquid but may be a solid. In most embodiments, the solid can be reconstituted with water prior to use.

As used herein, the term “amino acids” refers to a composition containing two or more amino acids. Amino acids include tryptophan, histidine, threonine, tyrosine, valine, methionine, isoleucine, leucine, phenylalanine, lysine, aspartic acid, cysteine, glutamic acid, glutamine, serine, glycine, alanine, proline, asparagine and arginine. In preferred embodiments, amino acids are provided by use of HYTb (See below).

In some embodiments, the first component comprises HYTd. The first component of the disclosed composition, including HYTd, is disclosed in U.S. Patent Application 61/500,527 filed Jun. 23, 2011 and U.S. patent application Ser. No. 13/530,552 filed Jun. 22, 2012 entitled Process for Making Chitin and Chitin Derivatives and published as US Patent Publication 2012/0329135 on Dec. 27, 2012, each expressly incorporated herein by reference.

As used herein, the term “chitin” refers to a biopolymer consisting predominantly of repeating units of beta-1-4-linked N-acetyl-D-glucosamine. Chitin is found in the natural environment as a primary structural material of the exoskeleton of animals such as arthropods, e.g., crustaceans, insects, spiders, etc., Mollusca, e.g., snails, squid, etc., Coelentara, e.g., organisms such as hydoids and jellyfish, and Nematoda, such as unsegmented worms. Chitin is also found in various fungi. Chitin can be extracted from these natural sources by treatment with alkali, or by a biodegradation process. The molecular weight of chitin varies depending on its source and method of isolation. In preferred embodiments, the chitin is derived as a solid from the biodegradation of chitin containing arthropods as described in U.S. Patent Application Ser. No. 61/289,706, filed Dec. 23, 2009 entitled “Biodegradation of Crustacean By-products”, U.S. Patent Application Ser. No. 61/299,869, filed Jan. 29, 2010 entitled “Biodegradation Process and Microbial Composition” and U.S. Patent Application Ser. No. 61/355,365 filed Jun. 16, 2010 entitled “Biodegradation Process and Composition” and U.S. patent application Ser. No. 12/974,924 filed Dec. 21, 2010 and published as US Patent Publication 2011/0151508 on Jun. 23, 2011 and PCT/EP2010/070285 filed Dec. 20, 2010 entitled Biodegradation Process and Composition, each of which are incorporated by reference herein in their entirety and referred to as the “biodegradation patent applications”. It is preferred that the chitin have a diameter of about 50 to 75 microns to facilitate its application via drip and spray irrigation systems.

As used herein, the term “chitosan” is a polysaccharide consisting predominantly of repeating units of D-glucosamine. Chitosan is obtained by deacetylation of chitin. The degree of deacetylation as compared to chitin is preferably greater than 50%, 60%, 70%, 80%, 85%, 90% and 95%. It is preferred that the level of deacetylation be sufficient to render the chitosan water soluble at acidic pH. The molecular weight of chitosan varies depending on its source and method of isolation. Chitosan includes chitosan oligomers. In preferred embodiments, chitosan is precipitated at pH 9.0 from the aqueous fraction obtained from the biodegradation of chitin containing arthropods such as described in biodegradation patent applications.

As used herein, the term “chitosan oligomer” refers to chitosan having 2 or more repeating units of D-glucosamine and, in the case of incomplete deacetylation of chitin, one or more units of N-acetyl-D-glucosamine. In preferred embodiments, the chitosan oligomers are derived from the aqueous fraction generated in the biodegradation of chitin containing arthropods such as described in the biodegradation patent applications. In some embodiments, chitosan oligomers are used as the second component of the microbial composition.

As used herein, the term “glucosamine” refers to an amino monosaccharide. In preferred embodiments, it is the sugar residue that forms the backbone of the biopolymers chitin and chitosan. Glucosamine is present in the aqueous fraction generated during the biodegradation of chitin containing arthropods such as described in the biodegradation patent applications. Glucosamine, chitosan and chitin have been shown to induce plants to generate defenses against pathogens. See Amborabé, B.-E.; Bonmort, J.; Fleurat-Lessard, P.; Roblin, G. Early events induced by chitosan on plant cells. J. Exp. Bot. 2008, 59, 2317-2324 and Garcia-Brugger, A.; Lamotte, O.; Vandelle, E.; Bourque, S.; Lecourieux, D.; Poinssot, B.; Wendehenne, D.; Pugin, A. Early signaling events induced by elicitors of plant defenses. Mol. Plant-Microbe Interact. 2006, 19, 711-724.

Second Components

The second component comprises a biological control agent. A biological control agent can, for example, protect a plant from pathogens or promote plant growth. The biological control agent is preferably selected from the group consisting of one or more pesticides, one or more non-pesticide organic molecules, one or more nutritional molecules and one or more non-pesticidal living systems.

Pesticides

As used herein a pesticide is any substance used to kill, repel, or control certain forms of plant or animal life that are considered to be pests. Common pesticides include herbicides for destroying weeds and other unwanted vegetation, insecticides for controlling a wide variety of insects, fungicides to prevent the growth of molds and mildew, bactericides for preventing the spread of bacteria, nematicides to control nematodes, algicides to control algae, avicides to control birds, molluscicides to control snails and slugs, virucides to prevent the spread of viruses, and rodenticides to control rodents such as mice and rats. Pesticides can be inorganic molecules, manmade organic molecules, or biological pesticide such as pesticide producing microorganisms and plants, and pesticide molecules derived from pesticide producing biological sources or any biocide used in agriculture.

Fungicides

Examples of inorganic fungicides include copper oxychloride, sulphur, potassium thiosulphate, calcium polysulphide, manganese phosphonate, fosetyl, aluminium and other such materials as outlined in The Pesticide Manual, A World Compendium, 16th Edition (November 2012) produced by the British Crop Protection Council (the “Pesticide Manual”), incorporated herein by reference.

Organic fungicides are manmade organic compounds and include carbamates, triazoles, strobilurins, chlorothalonil, prochloraz, iprodione, boscalid, priimicarb and other such materials as outlined in the Pesticide Manual.

Fungicides derived from a biological source include blasticidin, kasugamycin, mldiomycin, natamycin, streptomycin, validamycin, and Fallopia (Syn. Reynoutria) extract and other such materials as outlined in the section on Natural Products in the Manual of BioControl Agents, 4th Edition (November 2009), produced by the British Crop Protection Council, (the “BioControl Manual”), incorporated herein by reference.

Examples of microorganisms having fungicidal activity include Bacillus amyloliquifaciens FZB 24, Bacillus subtilis QST713, Paenibacillus polymyxa, Rhizobium radiobacter, Ampelomyces quisqualis, Candida oleophila, Coniothyrium minitans, Pythium oligandrum, Endothia parasitica, Erwinia carotovora, Fusarium oxysporum, Gliocladium catenulatum, Gliocladium virens, Phlebiopsis gigantean, Pseudomonas fluorescens, Pseudomonas syringae, Pseudomonas cepacia, Pseudomonas chloraphis, Streptomyces griseoviridis, Trichoderma harzianum, Trichoderma viride and other such materials as outlined in the BioControl Manual.

Insecticides

Examples of inorganic insecticides include borax (disodium tetra borate), calcium silicate, refined mineral oils and other such materials as outlined in the Pesticide Manual.

Organic insecticides are manmade organic compounds and include cypermethrin, deltamethrin, nicotine, carbosulfan, chlorpyrifos and dimethoate and other such materials as outlined in the Pesticide Manual.

Insecticides derived from a biological source include spinosad, abamectin, azadirachtin, milbemectin, rotenone, pyrethrins, Sabadilla extract and other such materials as outlined in the BioControl Manual.

Examples of microorganisms having insecticidal activity include Verticillium lecanii, Verticillium chlamydosporium, Bacillus sphaericus, Beauveria bassiana, Beauveria brongniartii, Burkholderia cepacia, Metarhizium anisopliae, Metarhizium flavoviride, Myrothecium verrucaria, Nosema locustae, Paecilomyces fumosoroseus, and Serratia entomophila. Other biological insecticides include insecticidal baculovirus, anagrapha, autographa, anticarsia cydia, omonella, heliocoverpa zea, mamestra etc and other such materials as outlined in the BioControl Manual.

Enhanced insecticidal activity of HYTd, in isolation and in combination with the above components, can be induced by including attractants, repellants or pheromones.

Herbicides

Examples of inorganic herbicides include mineral oils, non-ionic surfactants, borax (disodium tetra borate decahydrate), paraffinnic petroleumoil and other such materials as outlined in the Pesticide Manual.

Organic herbicides are manmade organic compounds and include sulphonyl urea, isoproturon, bromoxynil, chlorotoluron, trifluralin, diflufenican, pendimethalin, glyphosate, flufenacet, plant hormone disrupters and other such materials as outlined in the Pesticide Manual.

Herbicides derived from a biological source include bilanofos, a naturally synthesized herbicide, produced by the microorganism Streptomyces hygroscopius, acetic acid, corn gluten meal, pelergonic acid, citrus oil, clove oil, lemongrass oil and other such materials as outlined in the BioControl Manual.

Examples of microorganisms having herbicidal activity include Chondostereum purpureum, Pseudomonas gladioli, Chondostereum purpureum, Phytophthora palmivora and Colletotrichum gloeosporioides and other such materials as outlined in the BioControl Manual.

Non-Pesticide Organic Molecules

Non-pesticide organic molecules can be selected from the group consisting of plant hormones, plant elicitors, microbial metabolites, plant signaling molecules, plant extracts, fatty acids and essential oils.

Plant hormones include auxins, gibberelins, cytokinins, abscisic acid, and ethylene, and synthetic plant growth regulators, including 1-methylcyclopropene and paclobutrazol.

Plant elicitors include jasmonic acid, methyl-jasmonate, salicylic acid, methyl-salicylate, polyamines, and brassinosteroids.

Microbial metabolites include surfactins, lipopetides, lytic enzymes, phenazines, humic acids and fulvic acids.

Plant signaling molecules include malic acid, jasmonic acid, salicylic acid, siderophores, heptaglucoside, glycopeptides, systemin, oligogalacturonide.

Plant extracts include alginates, laminaria, garlic, mustard, chili, neem, aloe, nicotine, and ryania.

Fatty acids include oleic acids, caprylic acid, pelargonic acid (in conjunction with succinic acid, lactic acid, glycolic acid) potassium salts of fatty acids.

Essential oils include extracts of pine, clove, peppermint, lemongrass, citronella, Eucalyptus, neem, coconut, sunflower, lavender, Leptospermum (manuka), and Chenopodium.

Plant Nutritional Molecules

The plant nutritional molecules are selected from the group consisting of phosphites, thiosulphates, micro-nutrients, major nutrients and fertilizer.

Micro-nutrients include zinc, copper, manganese, molybdenum, silicon, boron, elenium, iron, and cobalt.

Major nutrients include nitrogen, phosphorous, potassium, magnesium, calcium, and sulphur.

Fertilizers include placement fertilizers containing nitrogen and phosphorous, nitrogen fertilizers and fertigation and hydroponic nutrient solutions.

As used herein, the term “liquid fertilizer” refers to an aqueous solution or suspension containing soluble nitrogen. The soluble nitrogen in the liquid fertilizer preferably comprises urea or a nitrogen containing salt such as ammonium hydroxide, ammonium nitrate, ammonium sulfate, diammonium sulfate, ammonium pyrophosphate, ammonium thiosulfate or combinations thereof. Aqua ammonia (20-24.6% anhydrous ammonia) can also be used.

Non-Pesticidal Living Systems

Non-pesticidal living systems include plant growth promoting rhizobacteria (PGPR), vascular arbuscular mycorrhizal fungi, endophytic bacteria and fungi, and rhizobia. PGPR include bacterial species with functions that promote plant growth, including biological nitrogen fixation and conversion, phosphorus and potassium solubilization in the soil, and the induction physiological responses within the host plant. These functions often result in increased root mass and growth rates, related to improved nutrient and water recovery, tolerance to biotic and abiotic stress, enhanced resistance to biotic stress (pests and pathogens).

Insect predators include Diglyphus isaea, Heterorhabditis spp., Steinernema spp. Amblyseius spp (barkeri, californicus, cucmeris, degenerans, fallacis) Anagrus atomus, Aphelinus adbominalis, Aphidius spp (colemani, ervi, matricariae) Aphidoletes aphidimyza, Aphytis spp (lignanensis, melinus) Chrysoperla carnea, Cotesia spp, Cryptolaemus montrouzieri, Dacnusa sibirica, Delphastus pusillus, Diglyphus isaea, Encarsia formosa, Eretmocerus californicus, Feltiella acarisuga, Galendromus occidentalis, Harmonia axyridis, Hippoderma convergens, Hypoaspis spp (aculeifer, miles) Leptomastix dactylopii, Metaphycus spp (bartletti, helvolus) Orius spp (albidipennis, insidiosus, laevigatus, majusculus) Phytoseilus persimilis, Podisus maculiventris, Trichogramma spp (brassicae, evanescens) Typhlodromus spp (occientalis, pyri) and the Heterorhabditis spp and Steinernema spp of parasitic nematodes, and other such materials as outlined in the BioControl Manual.

Other Components

In other embodiments, the first component and/or second component further comprises at least one of HYTa, HYTb and HYTc. In still other embodiments, the first and/or second component further comprises two or more of, HYTa, HYTb and HYTc. The first and/or second component further can comprise HYTa, HYTb and HYTc.

HYTa

As used herein, the term “HYTa” refers to a consortium of microbes derived from fertile soil samples and commercial sources. HYTa was deposited with the American Tissue Type Culture (ATTC), Rockville, Md., on May 19, 2010 with an assigned deposit designation of PTA-10973. Agricultural uses of HYTa are disclosed in US Patent publication 2012/0084866 published Apr. 5, 2012 entitled Microbial Process and Composition for Agricultural Use, incorporated herein by reference.

HYTb and HYTc

As used herein, the term “HYTb” refers to the aqueous fraction and “HYTc” refers to the solid fraction obtained from the biodegradation of chitin containing arthropods as described in the biodegradation patent applications.

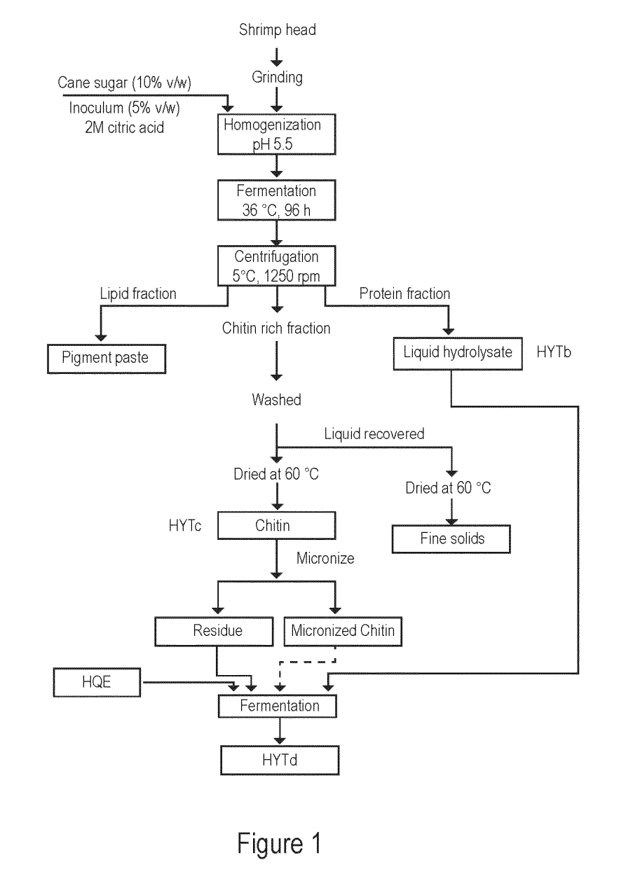

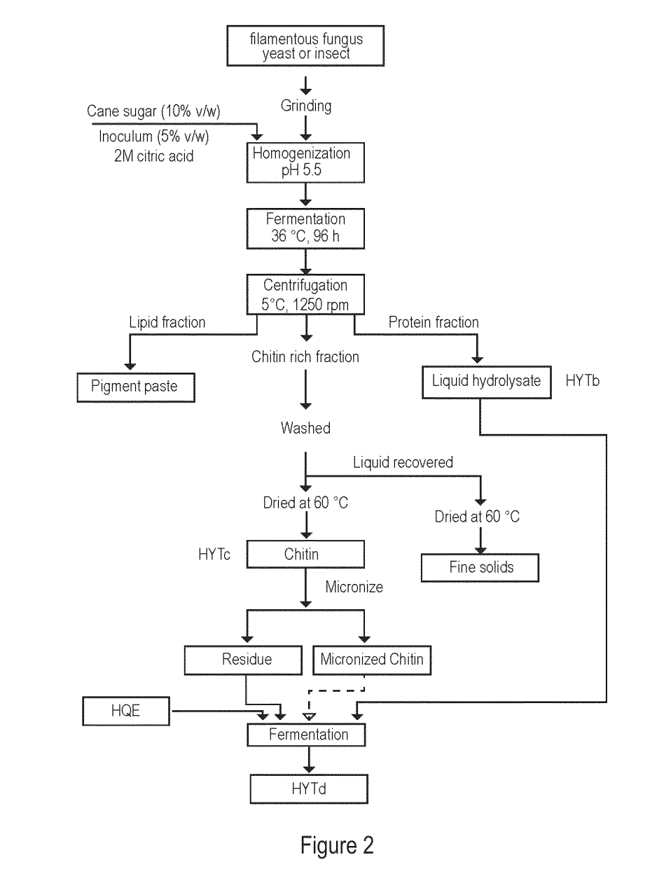

FIGS. 1 and 2 disclose the process for making HYTb from arthropods (FIG. 1) and from other chitin containing organisms such as fungi, yeast and insects (FIG. 2).

Briefly, in the arthropod biodegradation process a microbial composition is used to degrade the arthropod or waste components of the arthropod. It is a lactic acid fermentation process. The microbial composition contains microbes that produce enzymes that can degrade the chitin containing components of the arthropod to chitin, chitosan, N-acetyl glucosamine and glucosamine. It also contains microbes that produce enzymes that can degrade proteins and fats to produce amino acids and lipids.

A preferred microbial composition for arthropod degradation is referred to as HQE. HQE was deposited with the American Type Culture Collection (ATCC) Manassas, Va., USA on Apr. 27, 2010 and given Patent Deposit Designation PTA-10861.

In a preferred embodiment, the marine arthropod is a crustacean and the preferred crustacean is shrimp. Shrimp by-product comprises shrimp cephalothorax and/or exoskeleton.

In the biodegradation process, it is preferred that the fermentation be facultative aerobic fermentation. It is also preferred that the fermentation is carried out at a temperature of about 30° C. to 40° C. The pH is preferably less than about 6, more preferably less than about 5.5. However, the pH should be maintained above about 4.3. The fermentation is carried out for about 24-96 hours. In some embodiments, the fermentation is carried out for about 24-48 hours and more preferably 24-36 hours. These fermentation times are far shorter than the typical prior art fermentation times of 10 to 15 days to achieve substantially the same amount of digestion, albeit without detectable formation of chitosan and glucosamine.

The separation of the mixture is preferably by centrifugation. (e.g. about 920 g). Gravity separation can also be used but is not preferred because of the time required to achieve separation.

The mixture separates in to three fractions: solid, aqueous and lipid. The solid fraction comprises chitin and is designated HYTc. The aqueous fraction comprises protein hydroysate, amino acids, chitosan and glucosamine and is designated HYTb. The lipid fraction comprises sterols, vitamin A and E and carotenoid pigments such as astaxanthine.

It is preferred that HQE be used in the biodegradation process. In other embodiments, it is preferred that previously prepared HYTb be added to HQE or the fermentation broth. As described above, HYTb contains amino acids, chitosan, glucosamine and trace elements including calcium, magnesium, zinc, copper, iron and manganese. HYTb also contains enzymes such as lactic enzymes, proteases, lipases, chitinases, lactic acid, polypeptides and other carbohydrates. HYTb can also contain dormant microorganisms from a prior biodegradation process. Such microorganisms can become reactivated and, in combination with HQE, contribute to a more robust biodegradation process as compared to when HQE is used by itself as otherwise described herein

Other microbial compositions for the production of HYTb and HYTc are set forth in the following Table 1.

TABLE 1
Culture Composition

| Microorganism | 1 | 2 | 3 | 4 | 5 | 6 | 7 | 8 | 9 | 10 |
|---|---|---|---|---|---|---|---|---|---|---|
| Bacillus subtilis | X | X | X | X | | X | X | X | | X |
| Bacillus cereus | X | X | | X | | X | | X | | X |
| Bacillus megaterium | X | X | | | | | | | | |
| Azotobacter vinelandii | X | X | | X | | X | | X | | X |
| Lactobacillus | X | X | X | X | X | | X | X | X | |
| acidophilus | | | | | | | | | | |
| Lactobacillus casei | X | X | | X | X | | | X | X | |
| Trichoderma harzianum | X | X | X | X | | X | X | X | | X |
| Rhizobium japonicum | X | X | | X | | X | | X | | X |
| Clostridium | X | X | | | X | X | | | X | X |
| pasteurianum | | | | | | | | | | |
| Bacillus licheniformis | X | X | X | | X | X | X | | X | X |
| Pseudomonas | X | X | X | | X | X | | | | |
| fluorescens | | | | | | | | | | |
| Bacillus thuringiensis | X | | | | | X | X | X | X | X |
| Streptomyces | X | | | | X | X | X | X | X | X |
| Nitrobacter | X | | | | | | X | X | X | X |
| Micrococcus | X | | | | | | X | X | X | X |
| Proteus vulgaris | X | | | | | | X | X | X | X |

These microorganisms are preferably derived from HQE and are referred to as Bacillus subtilis ((SILoSil® BS), Bacillus cereus (Bioderpac, 2008), Bacillus megaterium (Bioderpac, 2008), Azotobacter vinelandii (Bioderpac, 2008), Lactobacillus acidophilus (Bioderpac, 2008), Lactobacillus casei (Bioderpac, 2008), Trichoderma harzianum (TRICHOSIL), Rhizobium japonicum (Bioderpac, 2008), Clostridium pasteurianum (Bioderpac, 2008), Bacillus licheniformis (Bioderpac, 2008), Pseudomonas fluorescens (Bioderpac, 2008), Bacillus thuringiensis strains HD-1 and HD-73 (SILoSil® BT), Streptomyces (Bioderpac, 2008), Micrococcus (Bioderpac, 2008), Nitrobacter (Bioderpac, 2008) and Proteus (Bioderpac, 2008). Each of these organisms can be readily isolated from HQE and recombined to form the disclosed microbial composition to degrade arthropods to make HYTb and HYTc.

HYTb contains amino acids (about 10-12 wt %), chitosan (about 1.2 wt %), glucosamine (about 1 wt %) and trace elements (about 6 wt %) including calcium, magnesium, zinc, copper, iron and manganese. It also contains enzymes such as lactic enzymes, proteases, lipases, chitinases among others, lactic acid, polypeptides and other carbohydrates. The specific gravity of HYTb is typically about 1.050-1.054. The average amino acid content in HYTb for certain amino acids is set forth in Table 2.

TABLE 2
Amino acid profile dry powder hydrolysates (mg per g dry weight)

| | Dry powder |
|---|---|
| Amino acid | hydrolysates |
| Aspartic acid | 38 |
| Glutamic acid | 39 |
| Serine | 16 |
| Histidine | 9 |
| Glycine | 28 |
| Threonine | 14 |
| Alanine | 36.1 |
| Proline | 25.8 |
| Tyrosine | 70 |
| Arginine | 22.2 |
| Valine | 20 |
| Methionine | 16.4 |
| Isoleucine | 18.3 |
| Tryptophan | 3.1 |
| Leucine | 23 |
| Phenylalanine | 39 |
| Lysine | 13 |
| Total | 431 |

The primary component of HYTc is chitin. It has an average molecular weight of about 2300 daltons and constitutes about 64 wt % of the composition. About 6% of HYTc contains minerals including calcium, magnesium, zinc, copper, iron and manganese, about 24 wt % protein and 6% water. It has a specific gravity of about 272 Kg/m³.

HYTd

HYTd is obtained by fermenting chitin with a microbial composition such as HQE suspended in HYTb. The process is similar to that described above for the production of HYTb and HYTc except that the substrate is chitin, e.g. HYTc, rather than chitin containing arthropods, filamentous fungi, yeast or insects.

FIG. 1 is a flow diagram showing the digestion of crustacean to form HYTb and HYTc. The HYTc and HYTb are subsequently processed with HQE (or consortium as set forth in Table 1) to form HYTd, a solution with relatively high amounts of chitosan and glucosamine as compared to HYTb.

FIG. 2 is a flow diagram showing the digestion of fungi, including filamentous fungi, yeast and/or insects to form HYTb and HYTc. The HYTc and HYTb are processed further with HQE to form HYTd.

HYTb already contains chitosan (about 0.5-1.5 wt %) and glucosamine (about 0.5-1.5 wt %). The amount of chitosan and glucosamine in HYTd ranges from about 2 wt % to 2.5 wt % chitosan and from about 2 wt % to 5 wt % glucosamine. This represents an increase in the amount of chitosan and glucosamine as compared to HYTb of about 0.5 wt % to 2.5 wt % chitosan and from about 0.5 wt % to 5 wt % glucosamine.

HYTd when undiluted is similar to HYTb but contains higher amounts of chitosan and glucosamine. HYTd contains amino acids (about 5 to 12 wt %) and trace elements (about 6 wt %) including calcium, magnesium, zinc, copper, iron and manganese. It also contains enzymes such as lactic enzymes, proteases, lipases, chitinases among others, lactic acid, polypeptides and other carbohydrates. In some embodiments, the degree of acetylation of the produced chitosan is 20% or less, preferably 15% or less, more preferably 10% or less, still more preferably 8% or less and most preferably 5% or less. The average amino acid content in HYTd it set forth in Table 3.

TABLE 3

| Amino acid | Concentration (wt %) |
|---|---|
| Aspartic acid | 1.029 |
| Threonine | 0.088 |
| Serine | 0.118 |
| Glutamic acid | 0.489 |
| Glycine | 0.552 |
| Alanine | 2.039 |
| Cysteine | 0.302 |
| Valine | 0.852 |
| Methionine | 0.126 |
| Isoleucine | 0.394 |
| Leucine | 0.632 |
| Tyrosine | 0.024 |
| Phenylalanine | 0.173 |
| Histidine | 1.880 |
| Lysine | 0.087 |
| Proline | 0.227 |
| Total amino acids | 10.416 |

HYTd preferable comprises 10-12 wt % L-amino acids (Aspartic acid, Glutamic acid Serine, Histidine, Glycine, Threonine, Alanine, Proline, Arginine, Valine, Methionine, Isoleucine, Tryptophan, Phenylalanine, Lysine and threonine) and 5 wt % glucosamine and chitosan. HYTd also preferable contains one or more or all of soluble minerals (P, Ca, Mg, Zn, Fe and Cu), enzymes and lactic acid from the chitin digestion process as well as other polysaccharides.

As used herein the term “glucosamine” includes glucosamine or a mixture of glucosamine and N-acetyl glucosamine. In most embodiments, HYTd contains glucosamine and N-acetyl glucosamine.

HYTd can also contain particulate chitin that has not been completely digested. In general, the fermentation mixture is filtered to remove large particles of chitin. The filtrate contains usually no more than 2 wt % chitin.

Depending on the second component used in combination with chitosan, glucosamine, and amino acids, and optionally other components disclosed herein such as HYTa, HYTb and HYTc, the combination (1) provides nutrients and elements in the soil that increase crop yields, (2) reduces greenhouse gas emissions, (3) increases the efficiency of mineral fertilizers, (3) reduces the use of conventional fungicides and other pesticides, (4) increases the production of plant growth regulators, (5) improves soil structure, tilth, and water penetration and retention, (6) cleans up chemical residues and (7) shifts soil pH toward neutral pH.

Activation of HYTa

HYTa may be activated before use.

In preferred embodiments, HYTa is activated by incubating an inoculum of HYTa in an aqueous solution for 24-168 hours to allow the microbes to grow and reproduce before being used in the process of treating soil, seeds, seedlings and/or plant foliage. The conditions of the incubation influence the overall initial properties of HYTa.

In one embodiment, an inoculum of HYTa is diluted with water in a ratio of 1/100 and allowed to incubate at a temperature of approximately 36° C. at a pH of 6.8-7.1 for about 24 to about 168 hours (7 days). HYTb can optionally be used during this activation. The nitrogen-fixing microbes Azotobacter vinelandii and Clostridium pasteurianum proliferate under reduced nitrogen growth conditions. In addition, as the oxygen concentration decreases, Lactobacilli Spp., including Lactobacillus acidophilus and Lactobacillus casei, proliferate. The HYTa obtained after this incubation retains the beneficial properties of HYTa but is particularly suited as a soil amendment for treatment of nitrogen-depleted soils given the nitrogen-fixation capabilities of Azotobacter vinelandii and Clostridium pasteurianum.

In another embodiment, HYTa may be mixed with other liquids, such as liquid nitrogen (fertilizer), herbicides, pesticides, or other chemistry, and applied to the crop either with or without activation.

If soil pathogen, such as filamentous fungi from the genus Fusarium or nematodes are present, or believed to be present, HYTa can be activated under substantially the same conditions but in the presence of chitin. The chitin stimulates the expansion of the chitin responsive microbes such as Pseudomonas fluorescens, Trichoderma harzianum, Bacillus thuringiensis, Streptomyces sp., Nitrobacter sp., Micrococcus sp., and Bacillus subtilis. HYTa obtained under these conditions has an antifungal, fungicidal, nematicidal and insecticidal properties to the extent such pathogens contain chitin. Such microbial compositions can be applied directly to the soil or to seed, seedlings and/or plant foliage. Such microbial compositions also have the ability to fix nitrogen as in the aforementioned incubation in the absence of chitin.

In addition to incubating with chitin, HYTa can be activated with chitin and amino acids. A preferred source of chitin is HYTc. When HYTc is used, the protein and minerals in HYTc are also present during the activation.

Further, HYTa can be activated in the presence of amino acids and chitosan. A preferred source of amino acids and chitosan is HYTb and/or HYTd. When HYTb and/or HYTd is used, glucosamine and the other components of HYTb and/or HYTd are also present during the activation.

Optionally, HYTa can be incubated with chitin, amino acids and chitosan. A preferred source of chitin is HYTc. A preferred source for amino acids and chitosan is HYTb and/or HYTd. When HYTb, HYTd and HYTc are used, the other components in these formulations are also present during activation.

### Agricultural Processes

Processes are also disclosed comprising contacting soil, foliage, seed or seedling with the above first and second components. The first and second components can be applied sequentially, simultaneously or as a mixture.

The process can be carried out by contacting soil to form a treated soil. In some cases, the process is repeated. In some cases, plants, seedlings or seeds are already present in the soil prior to treatment with the disclosed compositions. In other cases, plants, seedlings or seeds are transplanted to the soil after treatment with the disclosed compositions.

In general, before application the number of hectares or acres to be treated is determined. Then the recommended amount of each component per hectare or acre is multiplied by the area to be treated and diluted in sufficient water to irrigate or spray the soil or crop on the area to be treated. The same procedure can be followed for any additional liquid components used. Solid components can be applied directly as a solid or as a suspension in water. HYTc, for example is preferably ground to micron size particles prior to use.

The process can be carried out with infertile soil. Such soils generally are those were at least one of low cation exchange capacity, low water holding capacity, low organic matter content and low levels of available nutrients is present. In general, infertile soil does not support vigorous plant growth and/or produces low crop yields.

For non-soil systems such as hydroponics, the same protocol applies but with a daily distribution following the fertigation program.

The compositions can be used in connection with any plant including but not limited to alfalfa, banana, barley, broccoli, carrots, citrus, corn, cotton, cucumber, forage grass, garlic, grapes, leek, melon, onion, orchard crops, ornamental crops, palm, potato, raspberry, rice, soybean, squash, strawberry, sugar beet, sugarcane, sweet potato, tomato, turf grass, and watermelon.

When the disclosed composition is applied to soil, seed, seedling or foliage, it forms treated soil, treated seed, treated seedling, treated foliage and treated plants.

If the composition includes HYTa, treated soil, seed seedling or foliage can be identified by determining if microbes unique to HYTa are present. Microbes in HYTa that are particularly preferred to detect are Bacillus subtilis (SILoSil® BS), Bacillus thuringiensis strain HD-1, Bacillus thuringiensis strain HD-73 (SILoSil® BT) and Trichoderma harzianum (TRICHOSIL) each of which can be isolated from the HYTa deposit or obtained from Biotecnologia Agroindustrial S.A. DE C.V., Morelia, Michoacan, Mexico. Identification of one or more of these microorganisms can be further combined with the identification of other microbes in HYTa, if necessary, to confirm the presence of HYTa or that HYTa was present. Trichoderma harzianum (TRICHOSIL) was deposited with the ATCC on Oct. 6, 2011 and given Patent Deposit Designation PTA-12152. Bacillus subtilis (SILoSil® BS) was deposited with the ATCC on Oct. 7, 2011 and given Patent Deposit Designation PTA-12153. Bacillus thuringiensis strains HD-1 and HD-73 (SILoSil® BT) was deposited with the ATCC on May 31, 2012 and given Patent Deposit Designation PTA-12967.

Treated seed, seedlings, foliage and plants are similarly defined. In these cases, the microbes of HYTa are found on the surfaces of the treated seed, seedlings, foliage and plants.

In yet another embodiment, insect predators can be used in conjunction with the (1) first component, (2) the first and second component or (3) the first, second and additional components to treat soil, seed, seedlings or foliage. For example, HYTd can be applied prior to the release of Diglyphus isaea for the control of leaf miner Liriomyza huidobrensis. Such treatment increases plant response to the insect, stimulates cell repair and reduces the activity of the insect pest, increasing rates of parasitism.

Specific Compositions and Their Use

HYT nematode comprises 2000 ml HYTd, 500 ml Pasteauria penetrans, applied at 5000 ml per hectare, in placement fertilizer at planting.

HYT nematode WP comprises 1000 g HYTc, 1000 g dry form Bacillus mix and 500 g dry powdered alginate. It is applied to seed tubers at a rate of 2500 g per ton of seed.

The following HYTd formulations target specific pathogens in specific cropping situations.

HYTe comprises 2000 ml HYTd and 500 ml high density spore-forming plant growth promoting Rhizobacteria, predominantly Bacillus and Paenibacillus species. HYTe is applied at 2500 to 5000 ml per hectare.

Dependent on microbial composition, HYTe can be applied to soil, seed, seedling or foliage to stimulate growth and trigger plant immune responses.

Microbes contained within the formulation already carry approval for use as a suppressive and preventative bio-control agent, effective against a number of clearly identified plant pathogens. This formulation therefore is fully organic and can be registered as a biological fungicide. Its mode of action is generally preventative.

Applications include 1) seed treatment to suppress take-all in cereals; 2) soil application to suppress Rhizoctonia in potatoes; 3) foliar application to suppress mildew and Botrytis in soft fruit and 4) addition to hydroponic solution to suppress Fusarium in tomatoes

HYTf comprises 1000 ml HYTd, 500 ml phosphite, 500 ml thiosulphate and 500 ml high density spore-forming plant growth promoting rhizobacteria, predominantly Bacillus and Paenibacillus species. It is applied at 1000 to 1500 ml per hectare directly to foliage.

HYTf has clearly demonstrable impact on the infective capability of a wide range of plant pathogens, when used in either a preventative or a curative manner. Its mode of action is both preventative and curative.

HYTe or HYTf can be 1) used with placement fertilizer to control Rhizoctonia in potatoes, carrots, parsnips; 2) applied to seed to control Sclerotinia in oilseeds; 3) applied to foliage to control Botrytis in grapes, strawberries; 3) applied to root stock to control club root in brassic; 4) applied to soil to control Pythium and Fusarium affecting tomatoes.

Specific compositions include 1) HYTd with pyrethrin for extended control of insects such as aphids; 2) HYTd with triazole for extended control of foliar diseases affecting cereals; 3) HYTd with strobilurin for extended control of Rhizoctonia in root crops; and 4) HYT d with iron phosphate for extended control of slugs.

### Example 1

Observations of field experiments indicate that the efficacy and agronomic benefit of the second component can be enhanced when applied in association with the first component. For example, in-furrow application of azoxystrobin to control Rhizoctonia solani in potatoes often gives little direct yield increase, sometimes delaying germination and emergence of the treated crop, but does give high level disease control that safeguards economic value. When applied in conjunction with HYTd, significant increases in yield have been recorded, along with increased levels of control of Rhizoctonia, and significant reductions in Streptomyces scabies, a pathogen against which azoxystrobin has no registered activity. In addition, co-formulations of HYTd with plant growth promoting Rhizobacteria and mineral nutrition have produced similar levels of disease control as azoxystrobin, but with increased yields.

For example, field experiments with the potato variety Maris Piper grown under conventional fertilizer and irrigation practice, reviewed the impact of fungicide application with and without HYTd, on tuber yield and the expression of two common plant pathogens, Rhizoctonia solani and Streptomyces scabies. Replicated plots of each treatment generated the data from HYTd applied with the seed at planting (See Table 4).

TABLE 4

| Treatment | Yield t/ha | R. solani | S. scabies |
|---|---|---|---|
| Control-standard farm practice | 64.31 | 12% | 42% |
| 1. Fungicide-azoxystrobin applied | 62.17 | 2% | 46% |
| in furrow at planting at 3 L/ha | | | |
| 2. HYTd-applied at 4 L/ha, placed | 67.64 | 3% | 23% |
| below seed | | | |
| 3. Fungicide plus HYTd-combined | 68.97 | 2% | 21% |
| application of treatments 1 and 2 | | | |
| 4. HYTd applied as a co- | 73.04 | >1% | 9% |
| formulation of 4000 ml HYTd plus | | | |
| 500 ml of spore forming Bacillus | | | |
| consortium (subtilis, megaterans, | | | |
| circulans, amyloliquifiaciens) | | | |

### Example 2

Similarly, when used in the control of pathogens affecting small grain cereals, azoxystrobin gives significant levels of disease control. When applied in association with HYTd, disease development following azoxystrobin application was suppressed by an additional 14 to 21 days, and total grain yields increased by an additional 6% to 11%, dependent on growing conditions. Both yields and increased periods of disease suppression are further improved by the inclusion of plant growth promoting rhizobacteria with HYTd, as indicated by the data generated from replicated field experiments in Table 5.

TABLE 5

| | | Mildew | Mildew |
|---|---|---|---|
| | | level | level |
| | | 7 days | 21 days |
| | Yield | after | after |
| Treatment | t/ha | treatment | treatment |
| Control-standard farm practice | 10.09 | 19% | 36% |
| 1. Fungicide-azoxystrobin at 1250 ml per | 10.44 | 4% | 11% |
| hectare, applied topically at growth stage | | | |
| 37 | | | |
| 2. HYTd at 2500 ml per hectare, applied | 10.87 | 3% | 7% |
| topically at growth stage 37 | | | |
| 3. Fungicide plus HYTd-HYTd- | 11.03 | 2% | 6% |
| combined application of treatments | | | |
| 1 and 2 | | | |
| 4. HYTd applied as a co-formulation of | 11.76 | 2% | 4% |
| 4000 ml HYTd plus 500 ml of spore | | | |
| forming Bacillus consortium (subtilis, | | | |
| megaterans, circulans, | | | |
| amyloliquifiaciens) | | | |

### Example 3

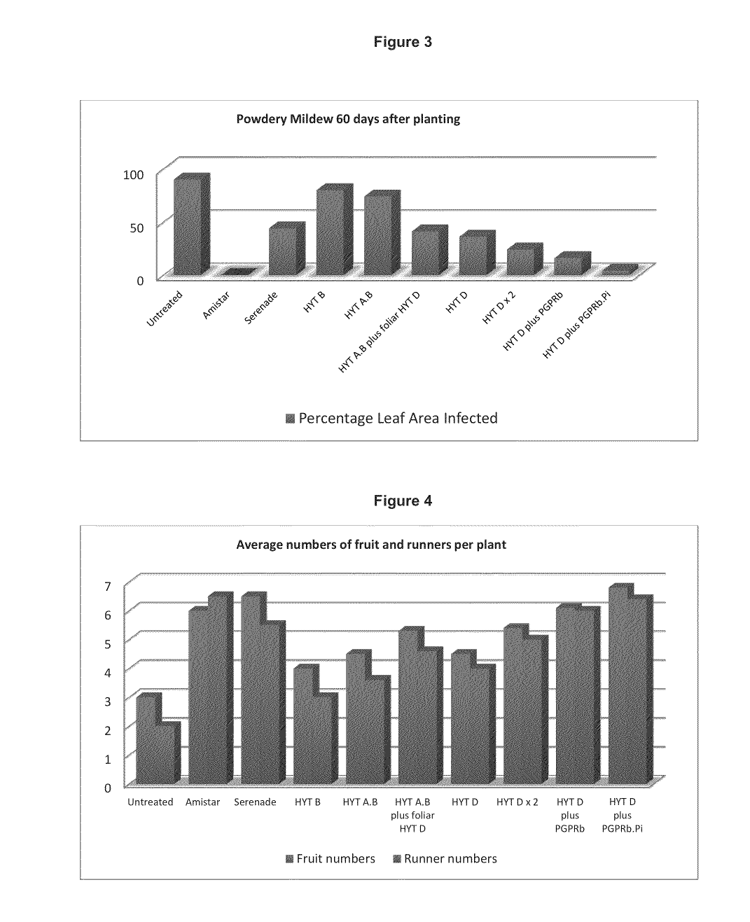

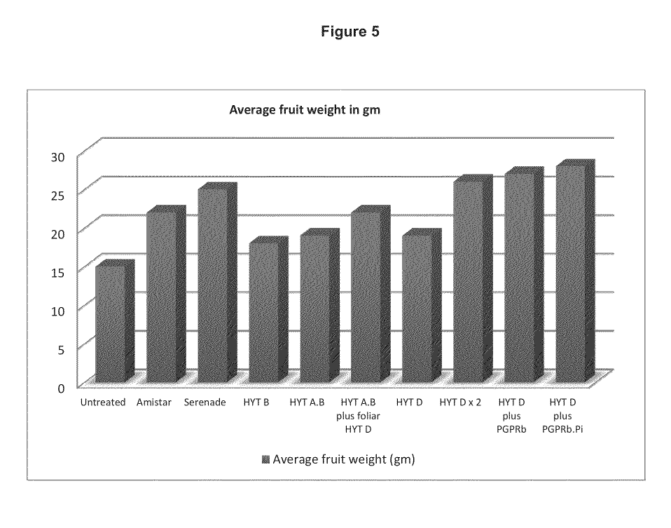

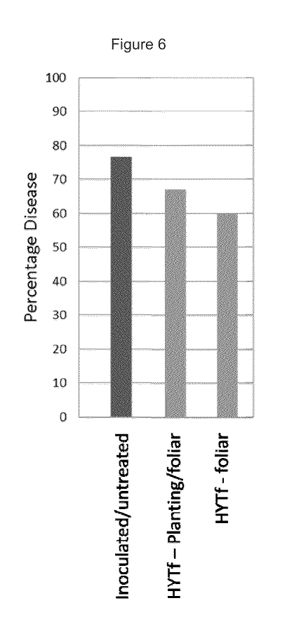

Evidence of the benefit of integrating HYTd with other materials has been generated by a number of field experiments. For example, with strawberries, a number of formulations of HYTd were used as a root dip at planting. Crops were assessed for physiological response, in terms of fruit and runner production, and for immunological response, in terms of the development of the pathogen Sphaerotheca macularis (powdery mildew of strawberries) 60 days after treatment. In this example, benchmark treatments of the fungicide Amistar (azoxystrobin applied at 1250 ml per ha applied topically) and the biocontrol Serenade (Bacillus subtilis QST713 applied at 10 L per ha topically) were used as comparisons. The HYT formulations were applied as root dips at planting, and include HYTb at 4 L per ha; HYTa at 2 L plus HYTb at 4 L per ha (following 72 hours of activation); HYTa at 2 L plus HYTb at 4 L per ha (following 72 hours of activation) followed by a topical application of HYTd at 2 L per ha immediately after planting; HYTd at 2 L per ha; HYTd at 2 L per ha followed by a topical application of HYTd at 2 L per ha immediately after planting; a co-formulation of HYTd at 2 L per ha plus 500 ml of the plant growth promoting rhizobacteria Bacillus subtilis FZB24; and a co-formulation of HYTd at 2 L per ha plus 500 ml of the plant growth promoting rhizobacteria Bacillus subtilis FZB24 and 850 ml of phosphonate as a complex with magnesium and zinc. Results are summarized in FIGS. 3, 4 and 5.

The studies show that HYTd has distinctly different performance characteristics to HYTb, both in terms of bio-stimulatory and bio-control responses, and that HYTd provides a good operating platform for conventional crop protection strategies and biological materials, in this instance plant growth promoting Rhizobacteria (PGPR) and inorganic phosphorous (Pi, phosphonate).

### Example 4

Enhanced resistance in potato to late blight (Phytophthora infestans) was demonstrated using HYTd combined with phosphite, thiosulphate, and rhizobacteria (HYTf). The susceptible potato cultivar Maris Piper was pre-treated either with HYTf or left untreated as a control. Plants were grown in the greenhouse until 7 days after complete emergence. HYTf was provided either as a foliar treatment or as a combined soil (at planting) and foliar treatment. Phytophthora infestans pathogen (isolate 13 A2) was spray inoculated on plants after HYTf treatments, treated plants incubated in a humid chamber for 24 hours (16° C.), plants transferred to the greenhouse for another 7 days, and then scored for foliar late blight symptoms. As shown in FIG. 6, compared to untreated controls, pre-treatment with HYTf reduced disease symptoms either by 33% (HYTf soil plus foliar application) or 40% (HYTf foliar application). This was statistically significant (P<0.05).

1. A composition comprising:
(a) a first component comprising chitosan, glucosamine and amino acids, where the concentration of said chitosan is greater than 1.5 wt % and said glucosamine is greater than 1.5 wt %; and
(b) at least one second component selected form the group consisting of (i) one or more pesticides, (ii) one or more non-pesticide organic molecules, (iii) one or more plant nutritional molecules and (iv) non-pesticidal living systems, where when there is no more than one second component said second component does not include the microorganisms in the consortium designated ATCC deposit PTA-10973 (HYTa) and the consortium designated ATCC deposit PTA-10861 (HQE).

2. The composition of claim 1 wherein said pesticide is an agricultural pesticide selected from the group consisting of fungicides, insecticides, herbicides, molluscicides and nematicides.

3. The composition of claim 1 wherein said pesticide is a biological pesticide selected from the group consisting of pesticidal microorganisms and pesticidal derivatives from a biological source.

4. The composition of claim 1 wherein said non-pesticide organic molecule is selected from the group consisting of plant hormones, plant elicitors, microbial metabolites, plant signaling molecules, plant extracts, fatty acids and essential oils

5. The composition of claim 1 wherein said plant nutritional molecules is selected from the group consisting of micro-nutrients, major nutrients and fertilizer.

6. The composition of claim 1 wherein said non-pesticidal living systems include plant growth promoting rhizobacteria (PGPR), vascular arbuscular mycorrhizal fungi, endophytic bacteria and fungi, rhizobia and insect predators.

7. The composition of claim 1 wherein said concentration of said chitosan is from 2 to 2.5 wt % and said glucosamine is from 2 to 6 wt %.

8. The composition of claim 1 further comprising chitin.

9. The composition of claim 1 wherein said first component further comprises trace elements.

10. The composition of claim 1 wherein said first component further comprises protein and polysaccharide.

11. The composition of claim 1 in solid form.

12. The composition of claim 1 wherein said first component comprises HYTd, wherein said HYTd is the liquid phase obtained from the digestion of chitin by ATCC deposit PTA-10861 in the presence of HYTb, wherein said HYTb is the liquid phase from the digestion of chitin containing organisms with ATCC deposit PTA-10861.

13. The composition of claim 1 further comprising at least one of, HYTa, HYTb and HYTc, wherein HYTa comprises ATCC deposit designated PTA-10973, and HYTb and HYTc comprise respectively the liquid and solid phases obtained from the fermentation of chitin containing organisms with a microbial composition comprising ATCC deposit PTA-10861.

14. The composition of claim 13 comprising two or more of, HYTa, HYTb and HYTc.

15. The composition of claim 13 comprising HYTa, HYTb and HYTc.

16. A process comprising contacting soil, seed, seedling or plant foliage with the components of the composition of claim 1.

17. The process of claim 16 wherein said contacting comprises the separate application of said first and second components.

18. The process of claim 16 wherein said contacting comprises the simultaneous application of said first and said second components.

19. The process of claim 16 wherein said contacting is with a composition comprising said first and said second components.

20. The process of claim 16 further comprising contacting soil, seed, seedling or plant foliage with at least one of HYTa, HYTb and HYTc, wherein HYTa comprises ATCC deposit designated PTA-10973, and HYTb and HYTc comprise respectively the liquid and solid phases obtained from the fermentation of chitin containing organisms with a microbial composition comprising ATCC deposit PTA-10861.

21. The process of claim 20 wherein said soil, seed, seedling or plant foliage is contacted with two or more of HYTa, HYTb and HYTc.

22. The process of claim 20 wherein said soil, seed, seedling or plant foliage is contacted with HYTa, HYTb and HYTc.

23. The process of claim 20 where one or more of HYTa, HYTb, and HYTc are used at different times.
